(19) United States
(12) Patent Application Publication
(10) Pub. No.: US 2025/0061358 A1
(43) Pub. Date: Feb. 20, 2025

(54) CLASSIFYING FAILURE MODES OF LARGE LANGUAGE MODELS (LLMS) FOR COMPUTER NETWORK ANALYTICS

(71) Applicant: Cisco Technology, Inc., San Jose, CA (US)

(72) Inventors: Grégoire Magendie, Lamorlaye (FR); Jean-Philippe VASSEUR, Combloux (FR); Pierre-André SAVALLE, Rueil-Malmaison (FR); Grégory MERMOUD, Venthône (CH)

(21) Appl. No.: 18/233,971

(22) Filed: Aug. 15, 2023

(51) Int. Cl. H04L 41/14; H04L 41/16

(52) U.S. Cl. CPC G06N 5/045; G06N 5/02; G06N 20/00

(57) ABSTRACT

In one implementation, a device uses a large language model associated with a network controller for a computer network to generate answers to questions regarding the computer network. The device determines that a particular answer to one of the questions represents a failure of the large language model. The device classifies the failure of the large language model as belonging to particular type of failure. The device provides an indication of the particular type of failure for display.

### TECHNICAL FIELD

The present disclosure relates generally to computer networks, and, more particularly, to classifying failure modes of large language models (LLMs) for computer network analytics.

### BACKGROUND

Networks are large-scale distributed systems governed by complex dynamics and very large number of parameters. In general, network assurance involves applying analytics to captured network information, to assess the health of the network. For example, a network assurance service may track and assess metrics such as available bandwidth, packet loss, jitter, and the like, to ensure that the experiences of users of the network are not impinged.

The recent breakthroughs in Large Language Models (LLMs) present new opportunities to develop enhanced user interfaces for network analytics systems. Indeed, LLMs such as ChatGPT and GPT-4 are able to interact with tools (also called plugins), to perform tasks such as searching the web, executing code, etc. Although the progress is impressive, these models remain extremely difficult to use in practice, as they exhibit flaws in their functioning, which are often extremely difficult to understand and troubleshoot. For instance, LLMs today are subject to the following issues: 1.) hallucinations whereby a model produces outputs that are syntactically and semantically correct, but do not reflect reality, 2.) over-confidence whereby the model provides highly uncertain answers with a high degree of confidence, 3.) biases whereby the model is implicitly influenced by its training corpus, 4.) factual and/or syntactically incorrect answers, a lack of reproducibility with different answers to the same questions, and 5.) high variance, among others.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for classifying failure modes of large language models (LLMs) for computer network analytics; and

FIG. 6 illustrates an example simplified procedure for classifying failure modes of LLMs for computer network analytics.

### DESCRIPTION OF EXAMPLE IMPLEMENTATIONS

### Overview

According to one or more implementations of the disclosure, a device uses a large language model associated with a network controller for a computer network to generate answers to questions regarding the computer network. The device determines that a particular answer to one of the questions represents a failure of the large language model. The device classifies the failure of the large language model as belonging to particular type of failure. The device provides an indication of the particular type of failure for display.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

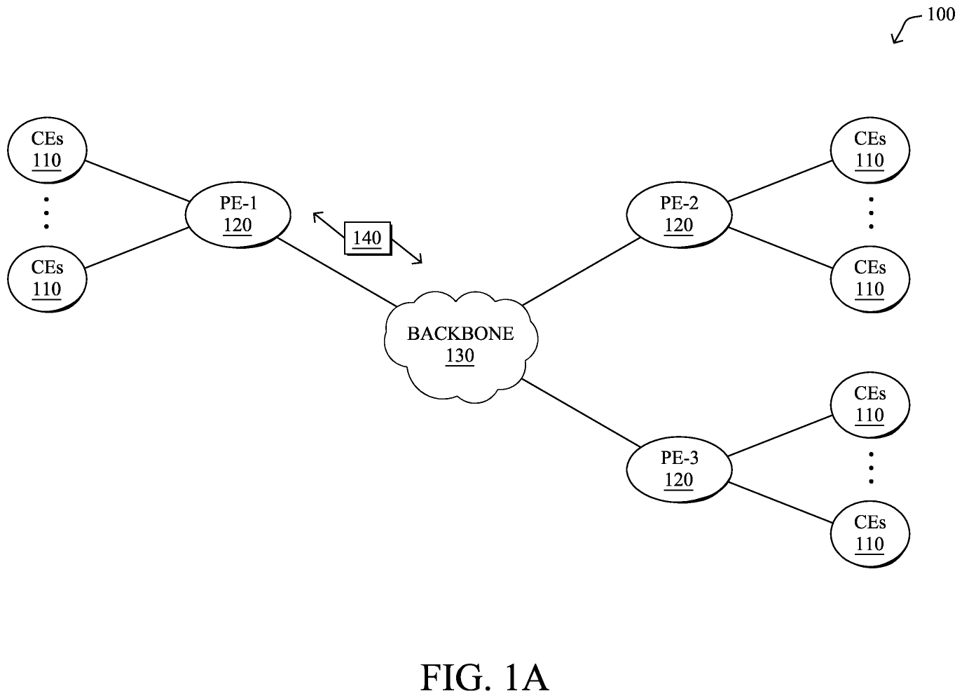

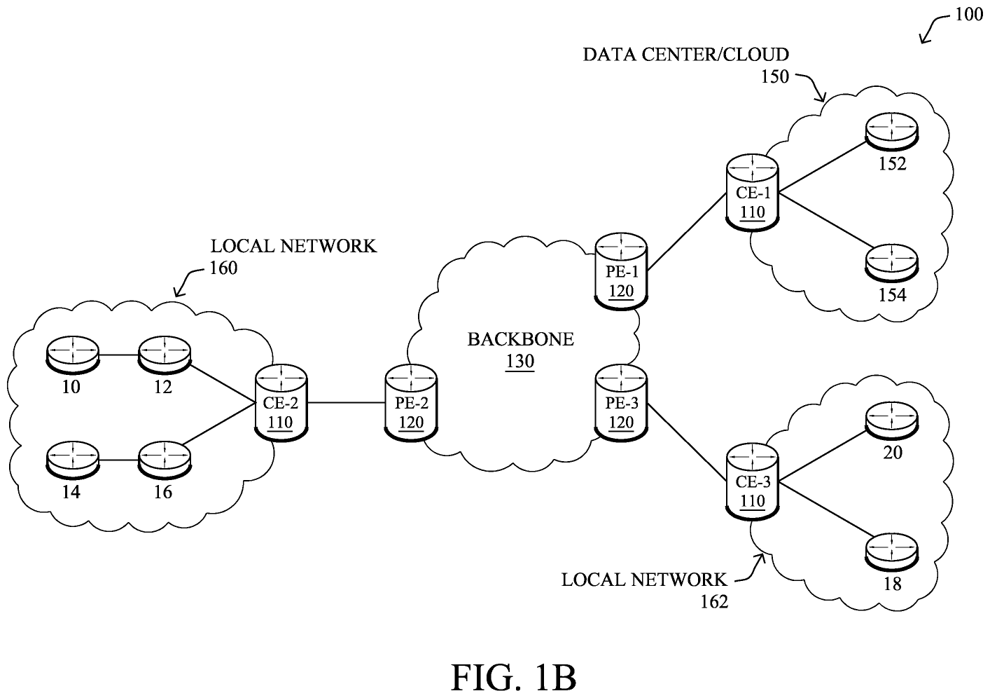

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

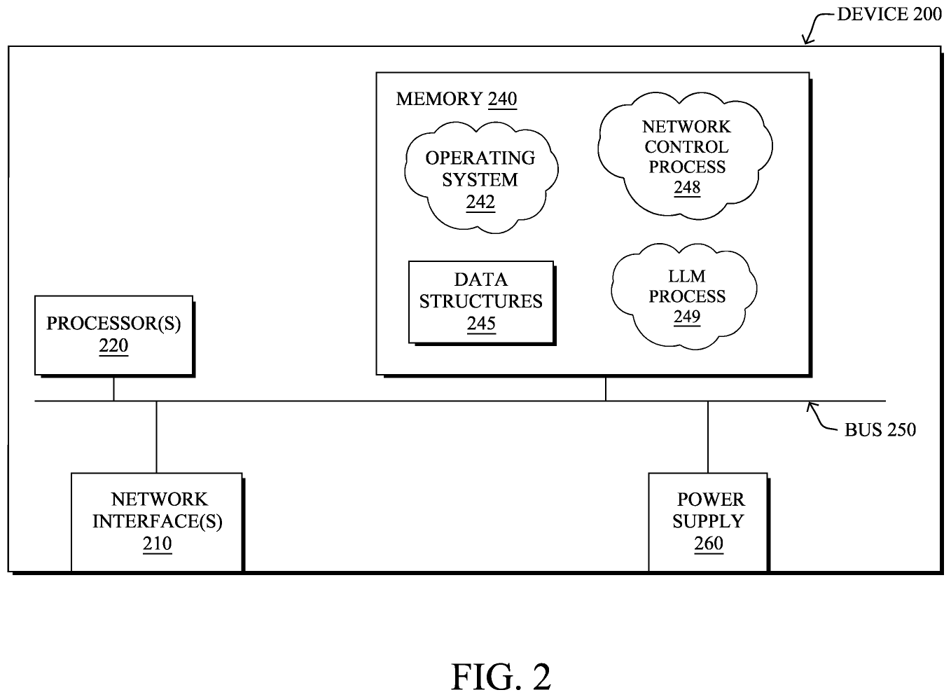

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or an LLM process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, network control process 248 and/or LLM process 249 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or LLM process 249 may include computer executable instructions that, when executed by processor(s) 220, cause device 200 to perform the techniques described herein. To do so, in some implementations, network control process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or LLM process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or LLM process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

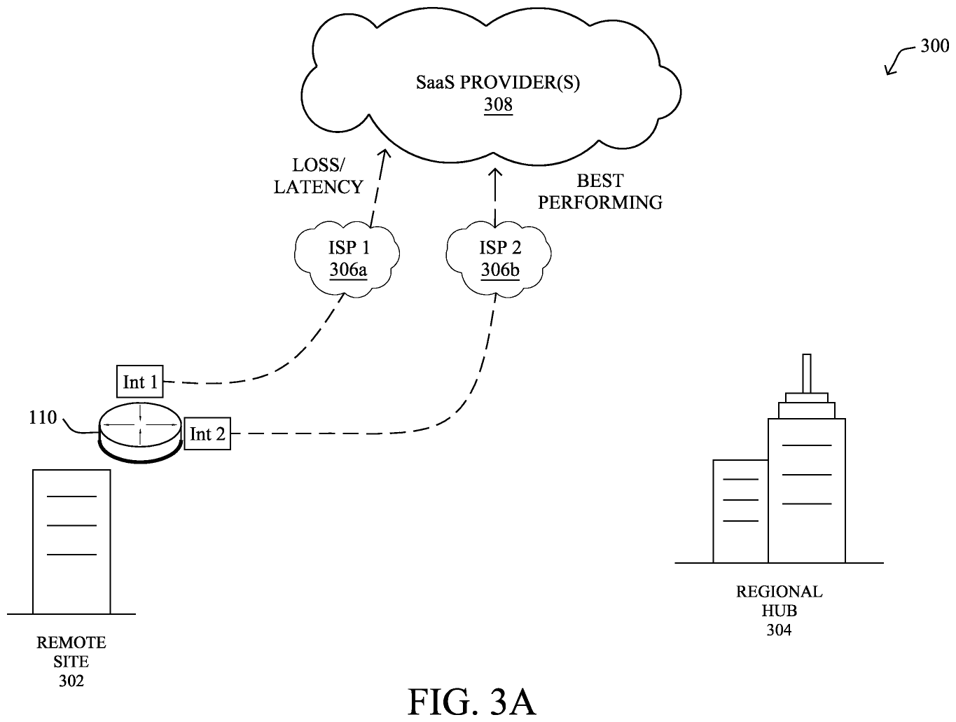

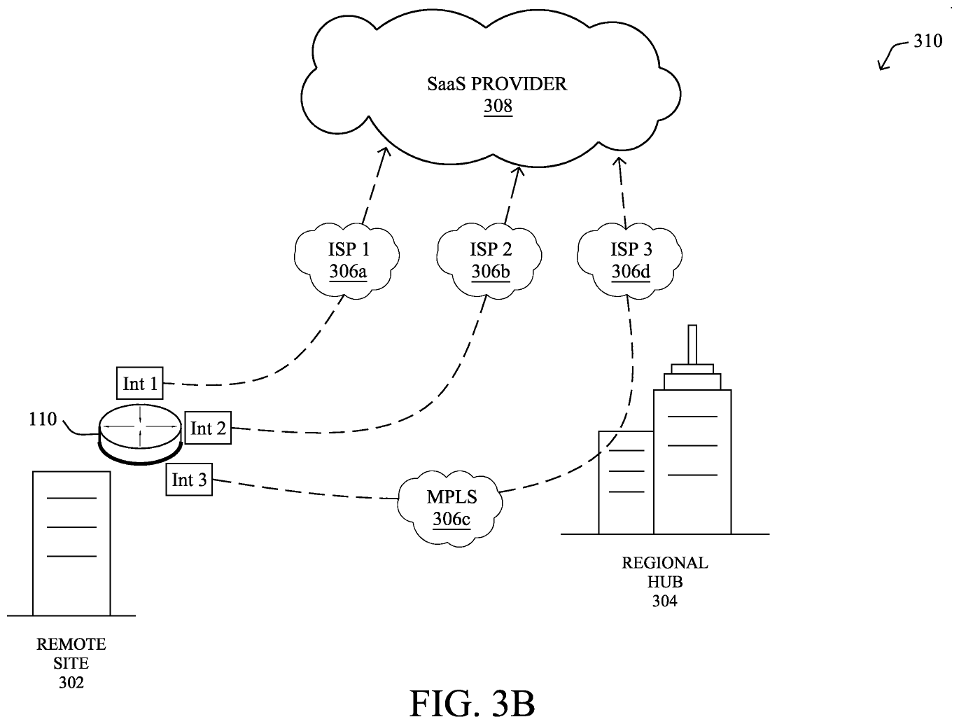

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

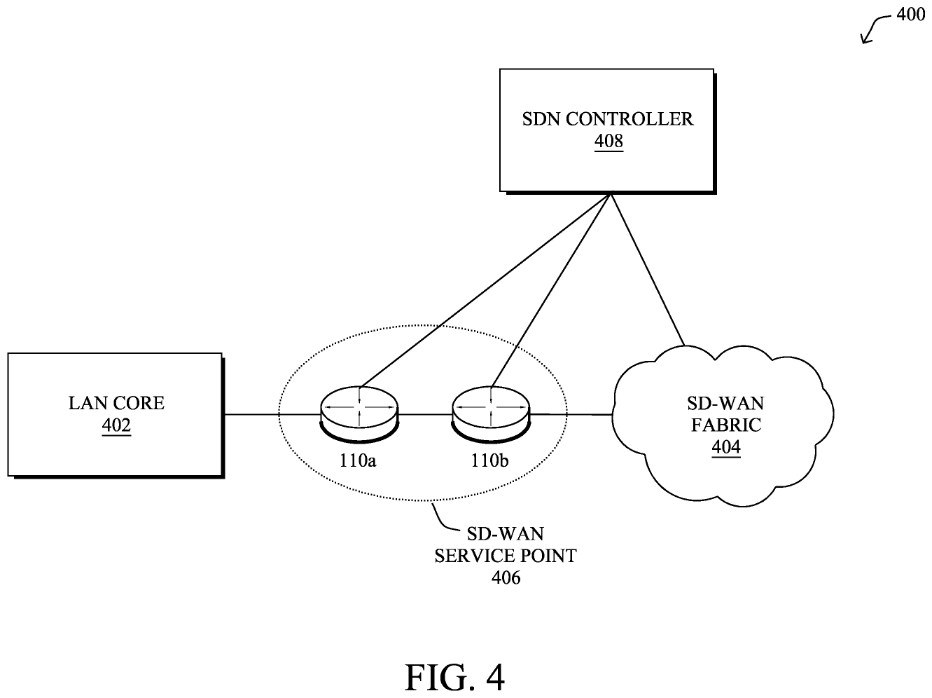

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region. SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words. SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, recent breakthroughs in LLMs, such as ChatGPT and GPT-4, pave the way to a myriad of new applications. For instance, the ability of these models to follow instructions allows for interactions with tools (also called plugins), to perform actions such as searching the web, executing code, etc. Although the progress is impressive, these models remain extremely difficult to use in practice, as they exhibit flaws in their functioning, which are often extremely difficult to understand and troubleshoot. They are subject to the following issues:
“Hallucinations” whereby an LLM produces outputs that syntactically and semantically correct, but do not reflect reality (some outputs are simply “invented” by the model).
Over-confidence whereby the LLM provides answers with a sense of confidence when in fact the answer is highly uncertain.
Biases whereby the LLM is implicitly influenced by its training corpus.
Mistakes by the LLM, which may result in either factually or even syntactically incorrect answers.
A lack of reproducibility whereby an LLM generates different answers to the same question, even when the request to the model is to minimize “randomness” and rather provide the most likely output (also called “temperature”).
Finally, LLMs can exhibit high variance in outputs for similar but slightly different inputs.

These phenomena can make it difficult to develop robust and reliable applications on top of LLMs, such as by using an LLM to enhance a users' interactions with a network control/analytics system. In addition, non-trivial applications often rely on an agent which breaks down processing into multiple LLM completion steps, and possibly allows interactions with external tools (such as searching a knowledge base or executing code). Combining multiple LLM steps can further compound the previously mentioned issues.

Taking a systematic approach to developing such applications is important. As with other data-driven systems, such as machine learning models, building comprehensive evaluation frameworks to measure generalization abilities as well as bias and variances of the models may be paramount. A simple example of an evaluation benchmark for an LLM-based application consists in sample questions and sample answers.

As introduced herein, in the context of networking, LLM-based applications can interact with network controllers to identify data-dependent questions (e.g., identifying unhealthy devices of some kind, or troubleshooting application issues for specific users). For such use cases, sample answers can be replaced by validation rules, that check that the answer from the model includes specific qualitative data (e.g., check that the answer to a question is negative or positive), or quantitative data (e.g., checking that the number of unhealthy devices is correctly reported by comparing against the controller's data via an API request). An evaluation benchmark composed of such question/validation rules could be a powerful tool to assess the robustness of an application.

However, to guide development and improvements of the LLM-based system, a simple success/failure feedback mechanism is not sufficient and actionable. Indeed, although such an approach could produce an accuracy score, doing so also does not it to characterize the cause of the failures (e.g., hallucinations, issues generating syntactically correct code, issues generally semantically correct code, issues formatting the result correctly, etc.). Alternatively, human inspection of the outputs of the model can, in principle, be used. In practice, though, doing so is also too expensive from a resource perspective.

### —Classifying Failure Modes of LLMs for Computer Network Analytics—

The techniques herein allow for the classification of failure modes of LLMs used for computer network analytics. In some aspects, the techniques herein propose leveraging an auxiliary LLM to qualitatively describe evaluation benchmark failures, as well as to criticize live outputs of the application, to guide improvements and to provide a richer picture of the performance and robustness of the model, allowing for more robust and accurate applications to be built. In some aspects the techniques herein provide rich evaluations of applications based on LLM agents in terms of a library of failure modes, through the use of unsupervised learning and/or constrained LLM decoding.

Illustratively, the techniques described herein may be performed by hardware, software, and/or firmware, such as in accordance with LLM process 249, which may include computer executable instructions executed by the processor 220 (or independent processor of interfaces 210) to perform functions relating to the techniques described herein, such as in conjunction with network control process 248.

Specifically, according to various implementations, a device uses a large language model associated with a network controller for a computer network to generate answers to questions regarding the computer network. The device determines that a particular answer to one of the questions represents a failure of the large language model. The device classifies the failure of the large language model as belonging to particular type of failure. The device provides an indication of the particular type of failure for display.

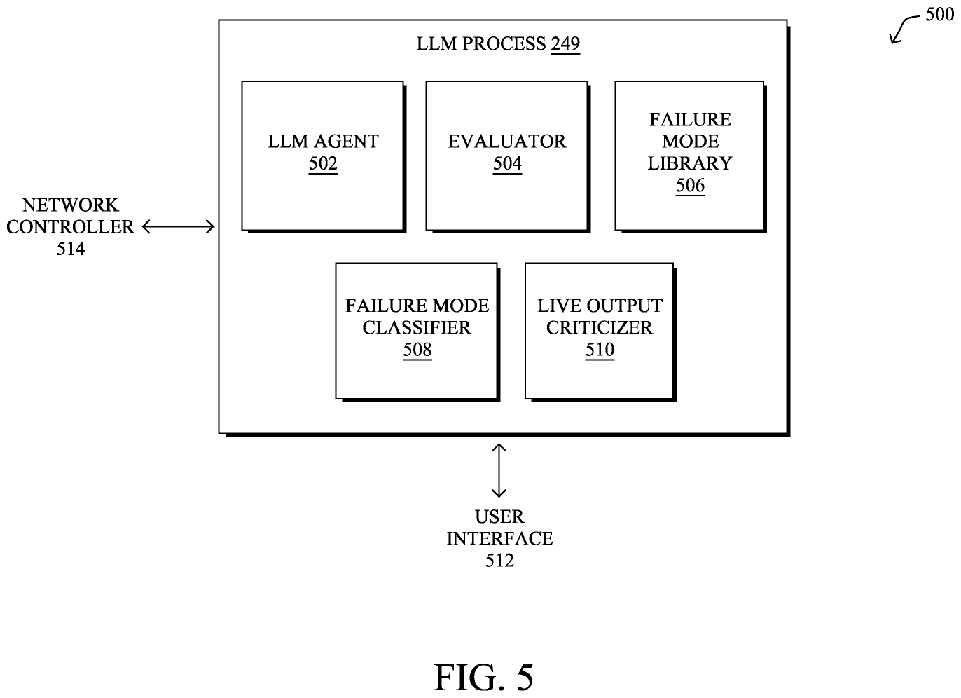

Operationally, FIG. 5 illustrates an example architecture 500 for classifying failure modes of LLMs for computer network analytics, according to various implementations. At the core of architecture 500 is LLM process 249, which may be executed by a controller for a network or another device in communication therewith. For instance, LLM process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, LLM process 249 may interface with a network controller 514, either locally or via

As shown, LLM process 249 may include any or all of the following components: LLM agent 502, evaluator 504, failure mode library 506, failure mode classifier 508, and/or live output criticizer 510. As would be appreciated, the functionalities of these components may be combined or omitted, as desired. In addition, these components may be implemented on a singular device or in a distributed manner, in which case the combination of executing devices can be viewed as their own singular device for purposes of executing LLM process 249.

In general, LLM agent 502 may be an LLM-based agent may leverage one or multiple LLMs, as well as additional logic (e.g., semantic search in a knowledge base, invoking tools such as code evaluation, etc.). During execution, LLM agent 502 may take as input a question or other textual input and produce as output an answer. For instance, in the case of LLM process 249 interfacing with network controller 514, the LLM(s) of LLM agent 502 may take as input questions received via a user interface 512 and, based on data provided by network controller 514 (e.g., log data, status data, etc.), return answers to user interface 512.

In various instances, LLM agent 502 may also generate an internal verbose, output in the form of a detailed log of all the steps in the chain. For example, the detailed log can consist of the following information:

### Chain:

Input: “how do I configure NAT on my vManage?”
Step: SEMANTIC_SEARCH
Output: Relevant documents: [doc1, doc2, doc3]
Step: LLM
Prompt:
   Using the following documents, answer this question:
   how do I configure NAT on my vManage?
   Documents:
      [doc1]
      . . .
      Output: To configure NAT, follow these steps: [ . . . ]. See also details in [doc1].

As shown, LLM process 249 may also include evaluator 504 which, for a given question, may validate whether a given answer from the LLM model used by LLM agent 502 is correct. In some implementations evaluator 504 may include a set of test cases that are defined by one subject matter experts (SMEs) whereby the answers supplied by these experts can be treated as ground truth.

By way of example, such a test case may look similar to the following:

### Test Case:

Question: how many devices are there on my SD-WAN network?
Validator:
   Run the following Python code to get the true device number from the controller:
      devices=vmanage.devices.get_device_list( )
         num_devices=len(devices)
   Validate that the output contains the number ‘num_devices “.

In some instances, evaluator 504 may also comprise an engine that can execute all the test cases using LLM agent 502, and output success/failure as well as the full chain log for each test case. To detect issues such as’ high variance,” evaluator 504 may perform multiple runs of the same test case for models that use sampling for decoding output tokens (this is often referred to having a non-zero temperature).

Failure mode library 506 may take the form of a repository of failure modes, with examples for each failure mode. In some cases, failure mode library 506 may be built manually by humans by listing failures modes, as well as previously observed examples of the failure in the past. Examples of this may include, among others:
Incorrect output formatting: e.g., the user asked for hostnames and IPs of devices in a site, but the model only returned the hostnames.
Fetched the wrong data from a controller: e.g., the user asked for information about wireless access points, but the model generated Python code to query the switch monitoring data instead.
Hallucinated data: e.g., the user asked for information about user John, but the model did not actually fetch it from the network controller and hallucinated some random values.

In other implementations, unsupervised learning may be combined with an LLM agent, such as LLM agent 502, to derive common failure modes. In this case, the process of building failure mode library 506 is automated using a database of previously failed test cases: More specifically:
The first step is to use an LLM to generate a textual description of each failure observed based on the corresponding chain of logs. Each description provides a clear understanding of the observed failure.
Next, these textual descriptions are converted into embeddings using an embedding model.
A clustering model is then applied to group the failed test cases based on similar embeddings. This process allows for the regrouping of test cases that exhibit similar failure modes, given that the embeddings carry semantically meaningful vector representations of each description.
Finally, for each cluster, an LLM is used to generate a summary, with examples, of the common failure mode that is observed across the points of the cluster, based on the concatenation of the descriptions of the corresponding test cases.
These summaries are then consolidated into failure mode library 506.

In both cases, the LLM can be directed to output only a failure mode out of a list. A sample prompt may read as follows:
[High-level context about the task]
The question was: [Question]
The answer was: [Answer]
Assess whether the answer is correct or not. If it is not, identify the type of issue with the answer from the list below. You must only respond with a single word from the list below:
   correct (when answer is correct)
   format (when the data in the answer is correct but not properly formatted)
   hallucination (when the answer has likely be hallucinated) etc.

To increase the robustness of the system, the LLM can be constrained to only output of the failure mode names from the library as follows, using constrained decoding:
For each failure mode name, tokenize the name using the LLM's tokenizer. For example, using the GPT-3 tokenizer:
   hallucination corresponds to tokens [18323, 1229, 1883]
   correct is a single token, and corresponds to
   format is a single token, and corresponds to
Constraint the LLM to only generate one of those failure mode names by only sampling tokens matching the ones in the failure mode library. For example, with the previous three failure modes, the first token out of the model can only be 18323, 30283 or 18982. This can be done by either boosting the logits for these three tokens, or simply discarding the logits for all other tokens completely. In common libraries such as transformers, this can be achieved using a Logits Processor.

LLM process 249 may further include failure mode classifier 508, which uses an auxiliary LLM to classify the chain log for a failed test case as representing a particular failure mode (e.g., by applying a failure label to the chain log for the failed test case). To do so, failure mode classifier 508 may build a prompt with any or all of the following information:
Context describing the failure modes from failure mode library 506. Alternatively, a fine-tuned model with the same information can be used.
The description of the test case, as well as the chain log for the failed test case instantiation. If the maximum context size of the model permits it, multiple runs can be included to account for high-variance issues.
A request to classify the failure into one of the modes from failure mode library 506. Additional techniques to improve accuracy of the classification such as Chain-of-Thought or asking the model to provide explanations can be used as well. The model should usually be instructed explicitly to only provide a class as output and nothing else. Alternatively, the model can be required to produce an accuracy score or a top-3 of the most likely failure classes, or can be sampled repeatedly.

The resulting information is then made available to a user via user interface 512, with various statistics related to the frequency of occurrences, the nature of the failure (e.g., a new LLM may start making new types of failures, etc.) for monitoring, as well as to application development teams to improve the agent.

In yet another implementation, failure mode classifier 508 may record the projected number of cases where the new type of failures is likely to occur. To that end, in a live system, the system may record the number of times a given question was asked that would lead to such a new class of failures, thus indicative of the emergency to avoid such a class of new failures. Furthermore, failure mode classifier 508 may also add a score of criticalities for different types of failures (e.g., a question related to networking performance metrics to which the LLM fails to answer is less likely to be impactful than a question related to code generation-such a score may be assigned per failure type according to SME policy).

LLM process 249 may also include output criticizer 510 which may run either offline on past outputs from the applications (for which a ground truth success/failure label is not available), or directly live as soon as the main application chains have completed. The auxiliary LLM is then used to classify the chain data into either one of the failure modes from failure mode library 506, or into a “success” class. In the latter case, it can be used in the following way:
If a failure has been predicted with high confidence, do not send the output to the user via user interface 512. Instead, either re-run the chain to get a different sampled output or indicate to the user that the application cannot answer the question.
With some probability, ask the user via user interface 512 their opinion of the output. In turn, output criticizer 510 can match the feedback from the user to one of the FML classes using an additional LLM run.

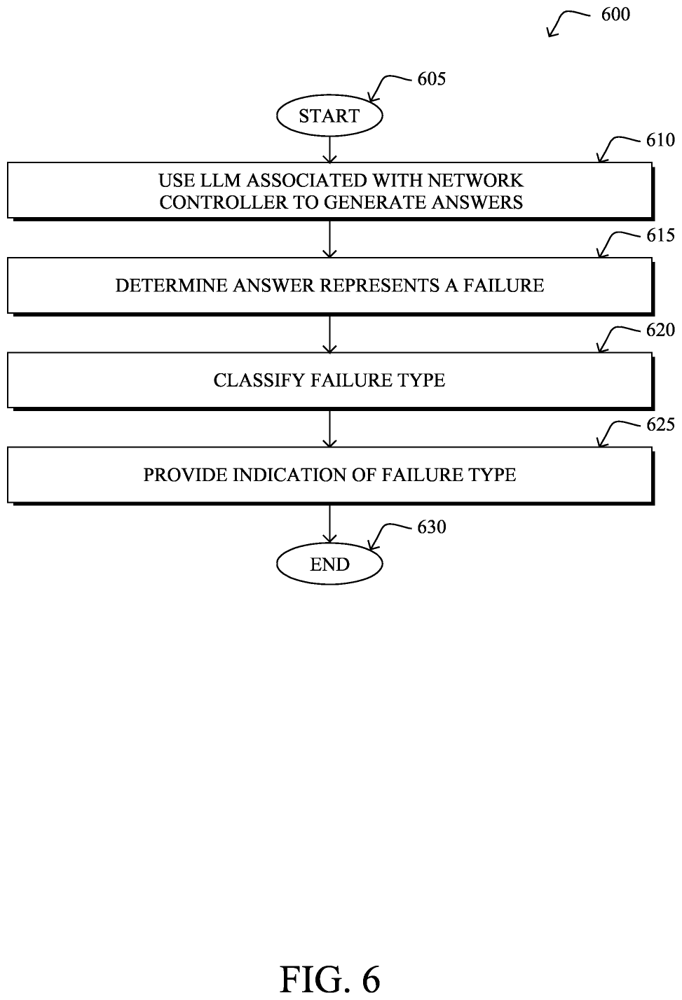

FIG. 6 illustrates an example simplified procedure 600 (e.g., a method) for classifying failure modes of LLMs for computer network analytics, in accordance with one or more implementations described herein. For example, a non-generic, specifically configured device (e.g., device 200), such as a router, firewall, controller for a network (e.g., an SDN controller or other device in communication therewith), server, or the like, may perform procedure 600 by executing stored instructions (e.g., LLM process 249 and/or network control process 248). The procedure 600 may start at step 605, and continues to step 610, where, as described in greater detail above, the device may use a large language model associated with a network controller for a computer network to generate answers to questions regarding the computer network. In some implementations, the large language model generates the answers in part by issuing a script or code to the network controller for execution.

At step 615, as detailed above, the device may determine that a particular answer to one of the questions represents a failure of the large language model. In some cases, the device may do so by using a predefined test case to validate the particular answer. For instance, the predefined test case may comprise a script or code for execution by the network controller. In some implementations, the device may also determine that it cannot validate a second answer from among the answers and obtain user feedback regarding whether the second answer is valid. In one implementation, the device obtains the user feedback based on a probability associated with the second answer.

At step 620, the device may classify the failure of the large language model as belonging to particular type of failure, as described in greater detail above. In some instances, the device uses a machine learning-based classifier to classify the failure of the large language model. In various implementations, the device may store a summary of a group of failures in a library. In turn, the device may use the library to classify the failure.

At step 625, as detailed above, the device may provide an indication of the particular type of failure for display. In various cases, the particular type of failure is at least one of: a hallucination failure, an over-confidence failure, a bias failure, a high variance failure, or a lack of reproducibility failure.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for classifying failure modes of LLMs for computer network analytics, it is to be understood that various other adaptations and modifications may be made within the spirit and scope of the implementations herein. For example, while certain implementations are described herein with respect to using certain models for purposes of predicting application experience metrics, SLA violations, or other disruptions in a network, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
using, by a device, a large language model associated with a network controller for a computer network to generate answers to questions regarding the computer network;
determining, by the device, that a particular answer to one of the questions represents a failure of the large language model;
classifying, by the device, the failure of the large language model as belonging to particular type of failure; and
providing, by the device, an indication of the particular type of failure for display.

2. The method as in claim 1, wherein the device uses a machine learning-based classifier to classify the failure of the large language model.

3. The method as in claim 1, wherein determining that the particular answer to one of the questions represents a failure of the large language model comprises:
using a predefined test case to validate the particular answer.

4. The method as in claim 3, wherein the predefined test case comprises a script or code for execution by the network controller.

5. The method as in claim 1, wherein the particular type of failure is at least one of: a hallucination failure, an over-confidence failure, a bias failure, a high variance failure, or a lack of reproducibility failure.

6. The method as in claim 1, further comprising:
determining, by the device, that it cannot validate a second answer from among the answers; and
obtaining, by the device, user feedback regarding whether the second answer is valid.

7. The method as in claim 6, wherein the device obtains the user feedback based on a probability associated with the second answer.

8. The method as in claim 1, wherein the large language model generates the answers in part by issuing a script or code to the network controller for execution.

9. The method as in claim 1, further comprising:
storing, by the device, a summary of a group of failures in a library.

10. The method as in claim 9, wherein the device uses the library to classify the failure.

11. An apparatus, comprising:
one or more network interfaces;
a processor coupled to the one or more network interfaces and configured to execute one or more processes; and
a memory configured to store a process that is executable by the processor, the process when executed configured to:
use a large language model associated with a network controller for a computer network to generate answers to questions regarding the computer network;
determine that a particular answer to one of the questions represents a failure of the large language model;
classify the failure of the large language model as belonging to particular type of failure; and
provide an indication of the particular type of failure for display.

12. The apparatus as in claim 11, wherein the apparatus uses a machine learning-based classifier to classify the failure of the large language model.

13. The apparatus as in claim 11, wherein the apparatus determines that the particular answer to one of the questions represents a failure of the large language model by:
using a predefined test case to validate the particular answer.

14. The apparatus as in claim 13, wherein the predefined test case comprises a script or code for execution by the network controller.

15. The apparatus as in claim 11, wherein the particular type of failure is at least one of: a hallucination failure, an over-confidence failure, a bias failure, a high variance failure, or a lack of reproducibility failure.

16. The apparatus as in claim 11, wherein the process when executed is further configured to:
determine that it cannot validate a second answer from among the answers; and
obtain user feedback regarding whether the second answer is valid.

17. The apparatus as in claim 16, wherein the apparatus obtains the user feedback based on a probability associated with the second answer.

18. The apparatus as in claim 11, wherein the large language model generates the answers in part by issuing a script or code to the network controller for execution.

19. The apparatus as in claim 11, wherein the process when executed is further configured to:
store a summary of a group of failures in a library.

20. A tangible, non-transitory, computer-readable medium storing program instructions that cause a device to execute a process comprising:
using, by the device, a large language model associated with a network controller for a computer network to generate answers to questions regarding the computer network;
determining, by the device, that a particular answer to one of the questions represents a failure of the large language model;
classifying, by the device, the failure of the large language model as belonging to particular type of failure; and
providing, by the device, an indication of the particular type of failure for display.
